(19) United States
(12) Patent Application Publication
(10) Pub. No.: US 2018/0326536 A1
(43) Pub. Date: Nov. 15, 2018

(54) APPARATUS FOR LASER HARDFACING USING A WOBBLING MOVEMENT

(71) Applicants: SIEMENS AKTIENGESELLSCHAFT, MÜNCHEN (DE); FRAUNHOFER GESELLSCHAFT ZUR FÖRDERUNG DER ANGEWANDTEN FORSCHUNG E.V., MÜNCHEN (DE)

(72) Inventors: FRANK MENTZEL, AACHEN (DE); GEORG BOSTANJOGLO, BERLIN (DE); BERND BURBAUM, FALKENSEE (DE); ANDRES GASSER, AACHEN (DE); STEFANIE LINNENBRINK, KREUZAU (DE); NORBERT PIRCH, AACHEN (DE); MICHAEL WEYLAND, BERLIN (DE)

(21) Appl. No.: 15/773,378

(22) PCT Filed: Oct. 11, 2016
(86) PCT No.: PCT/EP2016/074287

§ 371 Date: May 3, 2018

(30) Foreign Application Priority Data
Nov. 10, 2015 (DE) 10 2015 222 083.4

(51) Int. Cl. B23K 26/082; B23K 26/342; B23K 26/144; B29C 64/153

(52) U.S. Cl. CPC B23K 26/082; B23K 26/342; B22F 2003/1056; B29C 64/153; B23K 26/144

(57) ABSTRACT

A device for laser hardfacing is provided, in which a scanner installation and a feed installation for a material provided for hardfacing are disposed so as to be interconnected. The device furthermore includes a laser installation and a control installation. Wobbling of the laser beam during the laser hardfacing can be carried out by the device. A method for laser hardfacing using a wobbling movement is furthermore provided.

### CROSS-REFERENCE TO RELATED APPLICATIONS

This application claims priority to PCT Application No. PCT/EP2016/074287, having a filing date of Oct. 11, 2016, based on German Application No. 10 2015 222 083.4, having a filing date of Nov. 10, 2015, the entire contents both of which are hereby incorporated by reference.

### FIELD OF TECHNOLOGY

The following relates to a device for laser hardfacing using a wobbling movement of a laser beam, in which a scanner and a feed device are disposed in an interconnected manner.

### BACKGROUND

Laser hardfacing is associated with methods of hardfacing in which a surface buildup on a workpiece is performed by means of applying and simultaneously fusing an additional material. The material is often fed in a pulverulent form, for example as a metal powder, or in the form of a wire, is fused, and the fused material is applied. A laser which is suitable for locally heating and fusing the material of the workpiece serves as an energy source. The additional material is fed in a manner synchronous to the fusing of the material of the workpiece and is also fused, wherein said additional material connects to the material of the workpiece.

Laser hardfacing is a suitable method for repairing workpieces such as components of turbines, for example turbine blades. In order for a nucleation for initiating the solidification of the fused material and for a grain growth of the crystals formed herein in the ‘mushy zone’ to be generated in a targeted manner, the laser beam can be guided in the manner of a wobbling movement. On account thereof, the growth of a columnar phase solidification front is suppressed, or completely avoided, respectively. This wobbling of the laser beam is also referred to as a wobble strategy. The laser herein is reciprocated at up to 100 Hz, wherein a zigzag movement results on account of a superposition of the wobbling movement and the conventional advancing, the latter being ensured by a displacement installation. For example, circular, sinusoidal, figure-eight-shaped or elliptical movements are furthermore possible as a result of a mirror movement. Moreover, further wobbling movements of the laser beam controlled by software can be generated.

However, conventional systems for hardfacing are not conceived such that the laser radiation can be wobbled. There is therefore the object of enabling laser hardfacing while using the wobble strategy for machining components.

### SUMMARY

An aspect relates to a device for laser hardfacing using a pulverulent additive material, comprising:
a displacement installation;
a laser installation;
a feed installation;
a scanner installation; and
at least one control installation,
   wherein the scanner installation and the feed installation are interconnected.

The feed system herein is disposed so as to be combined with the scanner device. The connected assembly has the advantage that the scanner installation and the feed installation cannot be moved relative to one another during a coating process. Furthermore, an almost fissure-free microstructure of nickel-based super alloys having a large proportion of an intermetallic phase can be generated by the device. Improved material properties of a repaired component as compared to conventionally welded components can thus be advantageously achieved. The device is furthermore advantageous because higher build-up rates, for example of up to 16 cm³/h but potentially therebeyond, can be achieved on a workpiece by way of said device than by way of conventional means. Higher build-up rates are thus achieved than by way of conventional methods such as power cladding or micro cladding.

The laser installation of the device serves for generating and directing a laser beam. The laser installation is connected to the scanner installation by a glass fiber which is suitable for directing a laser beam from the laser installation up to the interior of the scanner installation. The scanner installation herein serves for deflecting the laser beam; mirrors which are conceived for directing a laser beam through the feed device and for wobbling the laser beam within the feed installation are in the scanner installation. The wobbling, or the wobbling movement, in relation to the laser beam refer to a repeated deflection of the laser beam.

The feed installation of the device serves for feeding an additional material which in the hardfacing is fused and applied to a material. The additional material which advantageously is present in a pulverulent form, is provided in a container which is provided to this end and fitted on a conveyor system, said additional material being supplied to the feed installation through a line. The feed installation is preferably a nozzle. It is preferable herein for the nozzle to be a slot nozzle. It is likewise preferable for the nozzle to be a round nozzle.

The displacement installation serves for generating the propulsion of the device. The control installation of the device serves for controlling the movements of the device according to embodiments of the invention relative to a workpiece by means of the displacement installation, and for controlling the wobbling movement of the laser beam. The control installation is preferably configured for controlling both the displacement installation as well as the scanner installation. It is likewise preferable for in each case a separate control installation for the displacement installation and for the scanner installation to be provided, wherein the control installations are configured for controlling the movements of the device, or directing the laser beam by means of the scanner installation, respectively.

A second aspect of embodiments of the invention relates to a method for repairing a workpiece from a high-temperature-resistant super alloy, comprising the following method steps:
S1) providing the workpiece which displays a defective location;
S2) providing a device for laser hardfacing, having a laser installation, a feed installation, a scanner system, and a control installation, wherein the scanner system and the laser installation are interconnected;
S3) providing an additive material by way of the feed installation and simultaneously directing a laser beam through the feed installation onto the defective location, wherein the laser beam wobbles.

The advantages of the method are analogous to those of the device according to embodiments of the invention. High-temperature-resistant super alloys, for example nickel-based super alloys, are known to a person skilled in the art. The standard procedures in repairing a damaged workpiece or component, above all the de-coating of the workpiece (when the latter has a coating), preparing the defective location, hardfacing, post-processing the welded location, and recoating are likewise known to a person skilled in the art.

A turbine blade is preferably used as the workpiece. The method is particularly suitable for workpieces having large dimensions, because the latter can be repaired in a material-saving manner and with high quality by the method.

Workpieces, or components, respectively, such as turbine blades conventionally have a coating, for example from ceramics. It is therefore preferable, when the workpiece has a coating, for a coating to be removed after step S2, and for a new coating to be applied after step S3. The material of the coating, for example ceramic coatings, is known to a person skilled in the art.

It is furthermore preferable for the additive material to be identical with the type of the basic material of the workpiece. It is furthermore preferable for the additive material to be provided in a pulverulent form. Alternatively, additive materials that are similar to the basic material of the workpiece can also be provided.

A third aspect of embodiments of the invention relates to a repaired turbine blade which has been repaired according to the method according to embodiments of the invention.

### BRIEF DESCRIPTION

Some of the embodiments will be described in detail, with reference to the following figures, wherein like designations denote like members, wherein:

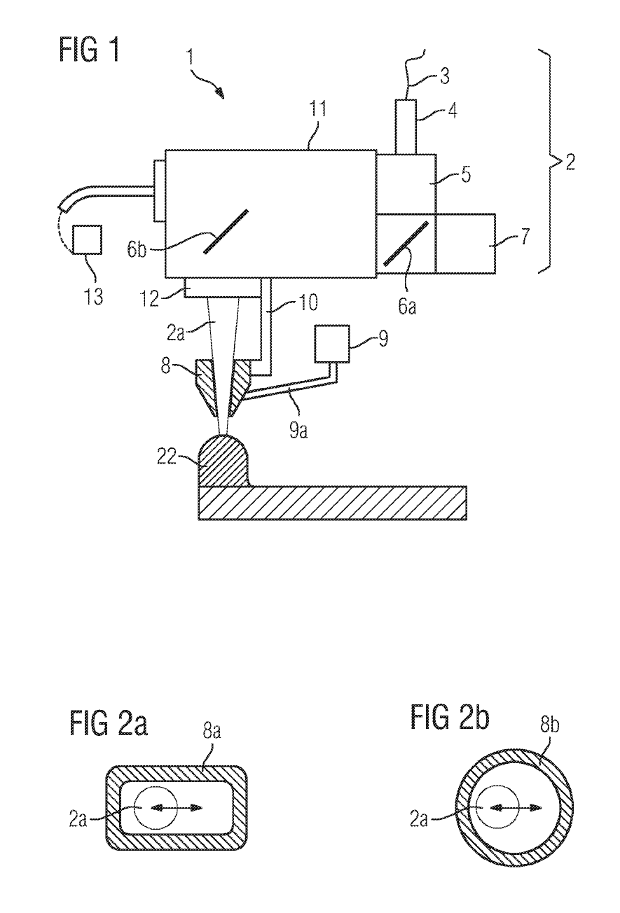

FIG. 1 shows a schematic illustration of an embodiment of the device according to embodiments of the invention;

FIG. 2a shows a schematic illustration of a first embodiment of a feed installation of the device;

FIG. 2b shows a schematic illustration of a second embodiment of a feed installation of the device;

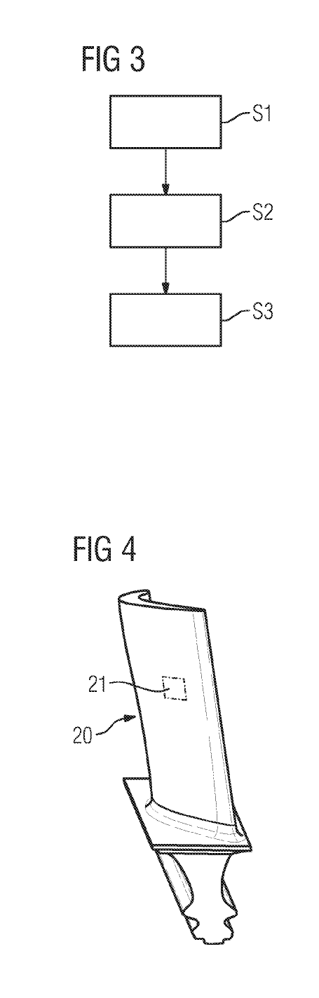

FIG. 3 shows a flow diagram of an embodiment of the method according to embodiments of the invention; and

FIG. 4 shows a turbine blade.

### DETAILED DESCRIPTION

A device 1 according to embodiments of the invention in an embodiment according to the illustration of FIG. 1 comprises a laser installation 2 having a fiber cable 3, a fiber plug 4, and an installation for collimating 5. The fiber cable 3 is preferably a glass fiber cable, but can also comprise another material, for example polymers. The fiber plug 4 serves for releasably connecting the fiber cable 3 to further components such as the installation for collimating 5, also referred to as the collimator 5. The laser installation 2 furthermore has a deflection mirror having a dichroic mirror 6a so as to direct the path of a laser beam 2a. A CCD camera 7 is fitted in the region of the deflection mirror 6a. Visible light is transmitted through the dichroic mirror 6a.

The light conducting fiber 3 is connected to a laser beam source (not shown). The laser radiation is generated in this laser beam source and guided by the fiber 3 into a scanner unit 11. The laser beam 2a is guided through a feed installation 8. The feed installation 8 is connected to a storage container 9 which contains an ideally pulverulent material which by way of an installation for conveying material 9a, in particular for conveying powder, is conveyed to the feed installation 8. The storage container 9 and the installation for conveying material 9a are disposed so as to be separate from the device 1. The feed installation 1 by means of a mounting 10 is fastened to a housing of the device 1, preferably to the housing of a scanner installation 11. The mounting 10 can be attached so as to be integrated or reversible in the housing of the scanner installation 11. Various embodiments of the feed installation 8 are illustrated in FIG. 2. The feed installation 8 in FIG. 2a is embodied as a slot-shaped nozzle 8a, also referred to as a slot nozzle 8a. The feed device in FIG. 2b is embodied as a round nozzle 8b. A wobbling movement of the laser beam 2a is induced in the nozzles.

The scanner installation 11 is preferably a complex system having all components required for directing the laser beam 2a. The scanner installation 11 can also be assembled from individual components. The scanner installation 11 is connected to the feed installation 8 in particular by way of the mounting 10. The scanner installation 11 is configured for directing the path of the laser beam 2a, in particular for deflecting the latter in a wobbling movement, as is indicated in FIGS. 2a and 2b. In order for a wobbling movement of the laser beam 2a to be generated, said laser beam 2a in this instance also being referred to as an oscillating laser beam 2a, the scanner installation 11 has a series of components. An actual scanner installation is provided for controlling the movement of the laser beam 2a in real time by means of the deflection mirror 6b. The deflection mirror 6b is configured for deflecting both the laser radiation as well as the light having wavelengths in the visible range. The deflection mirror 6b can also comprise an entire mirror system. The laser radiation impacts the mirror(s) and is reflected by the mirror(s). The direction in which the laser radiation is deflected depends on the current mirror position. A powerful lens 12, for example an F-Theta lens, is provided for focusing the laser beam 2a. The scanner installation 11 can furthermore comprise a filter for providing compressed air, a battery, and various cables for providing electricity, water lines for cooling, and installations for fitting. The enumeration is not exhaustive.

Alternatively, the scanner installation 11 can be configured so as to be controlled such that the deflection of the laser radiation is performed not only in a reciprocating manner but also such that sinusoidal, figure-eight-shaped, meandering, etc., deflections are enabled. In the superposition of the wobbling movement and the main advancement on the workpiece, or the component, respectively, zigzag-shaped, helical, etc., displacement paths thus result. A control installation 13 is provided for controlling the scanner installation 11. The control installation 13 is disposed outside the scanner installation 11 and is connected to the scanner installation by way of a cable 13a. The control installation 13 herein is preferably a computerized controller. Alternatively, the control installation 13 can also be integrated in a complex system of the scanner installation 11 and be located in the housing of the scanner installation 11.

A method for repairing a damaged location 21 of a turbine blade 20 is illustrated in FIG. 3. Herein, a turbine blade 20, the surface of the latter having a damaged location 21 as is shown in FIG. 4, is provided in a first step S1. The turbine blade 20 comprises, for example, a nickel-based super alloy, or alternatively another or a further metallic high-temperature-resistant material. The coating, conventionally from a ceramic material, for example metal oxides, is removed in a second step S2. The device 1 for laser hardfacing is provided in a third step S3. An additive material from the storage container 9 is conveyed by way of the installation for conveying material 9a to the feed installation 8 in a fourth step S4, and by way of the feed installation 8 is fed to a region of the damaged location 21. The additive material is provided in a pulverulent form and preferably so as to be identical with the type of the material of the turbine blade 20. Alternatively, the additive material can also be different from that of the basic material, but similar to the latter. The feeding by means of the feed installation 8, which is configured as a nozzle, is carried out by a nozzle application onto the damaged location 21. The laser beam 2a is simultaneously directed through the feed installation 8, said laser beam 2a fusing both the material of the turbine blade 20 as well as the pulverulent additive material. The scanner installation 11 herein ensures a wobbling movement, or an oscillation, respectively, of the laser beam 2a. The oscillation herein is up to 100 Hz. The wobbling movement of the laser beam 2a is linear, for example (FIGS. 2a, 2b). The wobbling movement herein is performed transversely to the advancing direction of the device 1 relative to the surface of the turbine blade 20. A new coating 22 is built up at the location above which the device 1 is currently located and where the laser beam 2a meets the material.

The device 1 during the method is guided, even repeatedly, over the damaged location until the material of the turbine blade 20 at the damaged location 21 has been completely renewed. The movement of the device 1 across the damaged location 21, and the frequency of the oscillation of the laser beam 2a, are preferably controlled by the control installation 13. Alternatively, as has been described above, in each case one control installation can be present for the movement of the device 1, in particular for a displacement installation that generates the movement, and for the control of the scanner installation 2, in particular of the frequency of the oscillation of the laser beam 2a.

Although the invention has been illustrated and described in greater detail with reference to the preferred exemplary embodiment, the invention is not limited to the examples disclosed, and further variations can be inferred by a person skilled in the art, without departing from the scope of protection of the invention.

For the sake of clarity, it is to be understood that the use of “a” or “an” throughout this application does not exclude a plurality, and “comprising” does not exclude other steps or elements.

1. A device for laser hardfacing using a pulverulent additive material, comprising:
a displacement installation;
a laser installation;
a feed installation;
a scanner installation; and
a control installation,
wherein the scanner installation and the feed installation are interconnected,
wherein the scanner installation is configured for directing a laser beam through the feed installation, and for wobbling the laser beam within the feed installation.

2. (canceled)

3. The device as claimed in claim 1, wherein the feed installation is a nozzle.

4. The device as claimed in claim 1, wherein the nozzle is a slot nozzle.

5. The device as claimed in claim 1, wherein the nozzle is a round nozzle.

6. The device as claimed in claim 1, wherein the control installation is configured for controlling a wobbling of the laser beam.

7. A method for repairing a workpiece from a high-temperature-resistant super alloy, comprising the following method steps:
S1) providing the workpiece which displays damage;
S2) providing a device for laser hardfacing, having a laser installation, a feed installation, a scanner installation, and a control installation, wherein the scanner installation and the feed installation are interconnected;
S3) applying an additive material by way of the feed installation and simultaneously directing a laser beam through the feed installation onto the defective location, wherein the laser beam wobbles.

8. The method as claimed in claim 7, wherein a turbine blade is used as the workpiece.

9. The method as claimed in claim 7, wherein, when the workpiece has a coating, a coating is removed after step S2, and a new coating is applied after step S3.

10. The method as claimed in claim 7, wherein the additive material is identical with the type of the material of the workpiece and is provided in a pulverulent form.

11. A repaired turbine blade repaired according to the method as claimed in claim 7.
